(19) United States
(12) Patent Application Publication
(10) Pub. No.: US 2015/0210462 A1
(43) Pub. Date: Jul. 30, 2015

(54) COMBINED MEDICAMENT AND BEVERAGE CONTAINER

(71) Applicant: Discovery, Inc., Ross, CA (US)

(72) Inventor: Joseph Milani, Chicago, IL (US)

(21) Appl. No.: 14/608,162

(22) Filed: Jan. 28, 2015

Related U.S. Application Data
(60) Provisional application No. 61/932,352, filed on Jan. 28, 2014.

(51) Int. Cl. B65D 81/32; B65D 6/00; B65D 13/02; A61J 1/03; B65D 25/54

(52) U.S. Cl. CPC B65D 81/3205; A61J 1/03; A61J 1/1418; B65D 25/54; B65D 13/02; B65D 11/20

(57) ABSTRACT

A combined medicament and beverage container includes a first reservoir, a second reservoir, and a lid 12. The first reservoir, second reservoir, and lid 12 all have substantially the same outer diameter at a point where the first reservoir, second reservoir and lid 12 mate in order to provide a smooth exterior where they mate. The first reservoir, second reservoir, and lid 12 each have coupling portions for joining the parts together. The coupling portions are configured to prevent a liquid stored in the respective reservoir from leaking therefrom. The container is reusable.

### FIELD

The examples described herein concern a combined medicament, such as a pill, capsule, or liquid medicine, and beverage container, such as a container for holding a small amount of water to be swallowed with the medicament.

### BACKGROUND

The term medicament, as used herein, is meant to describe any type of medicine, including pills, capsules, or liquid medicine. Many people take medicine at least once a day. If they are traveling or are away from home, they may not have access to a drink to aid in swallowing the medicine. While they could carry the pills and drink in separate containers, containers for beverages tend to be too large to carry comfortably in a purse or pocket. Thus, beverage containers often become separated from the medicine containers and can be forgotten or easily lost. In addition, if traveling by air, the size of the beverage container that may be taken through security is limited to 3 ounces. Most beverage containers, such as bottles of water, are larger than 3 ounces.

### SUMMARY

An example beverage container is shown and described. The example container holds both medicine and pills, but in separate containers so that they do not mix. The container has a first reservoir for holding a beverage and a second reservoir for holding a medicament. Both reservoirs are water tight and will not leak. In addition, the container is easily washable and reusable. The container has a smooth exterior surface so that it will not be caught up on other items in a pocket or purse of a user.

### BRIEF DESCRIPTION OF THE DRAWINGS

FIG. 1 is a side view of an example combined medicament and beverage container according to the invention;

FIG. 2 is an exploded view of the example container of FIG. 1, showing how the various parts may be separated from one another;

FIG. 3 is a perspective view of the top part of the example container of FIG. 1, shown with the lid 12 removed and with pills installed therein;

FIG. 4 is perspective view of a person drinking water from the bottom part of the example container of FIG. 1;

FIG. 5 is a top view of the example container of FIG. 1;

FIG. 6 is a bottom perspective view of the lid 12 of the example container of FIG. 1;

FIG. 7 is a side view of the lid 12 of the example container of FIG. 1;

FIG. 8 is a top view of the open base of the example container of FIG. 1;

FIG. 9 is a side view of the base of the example container of FIG. 1;

FIG. 10 is a top perspective view of the base of the example container of FIG. 1;

FIG. 11 is side view of the intermediate portion of the container of FIG. 1 that is used to hold medicament;

FIG. 12 is a top perspective view of the intermediate portion of FIG. 11; and

FIG. 13 is a bottom perspective view of the intermediate portion of FIG. 11, showing the closed bottom of the intermediate portion along with the screw thread portions that we used to join the intermediate portion to the base.

### DETAILED DESCRIPTION

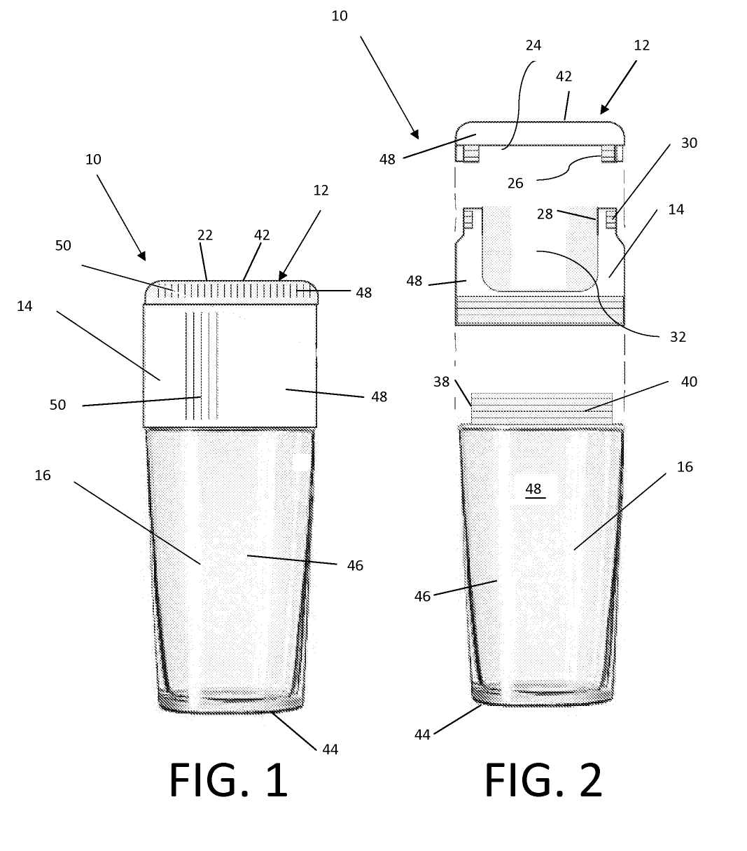

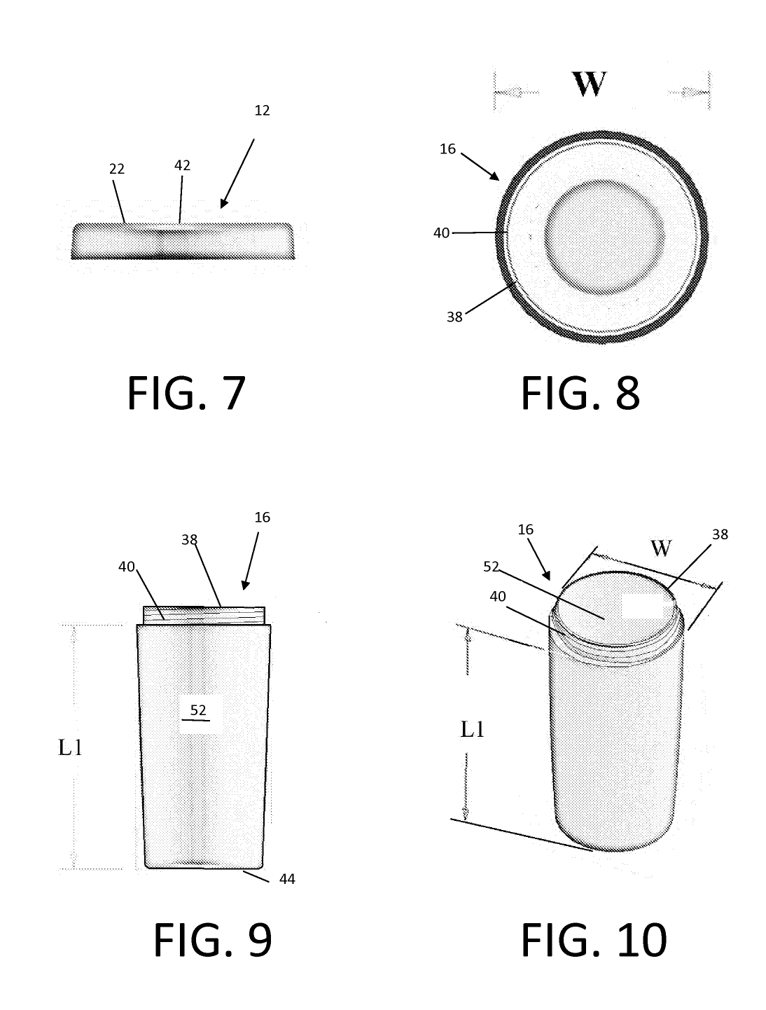

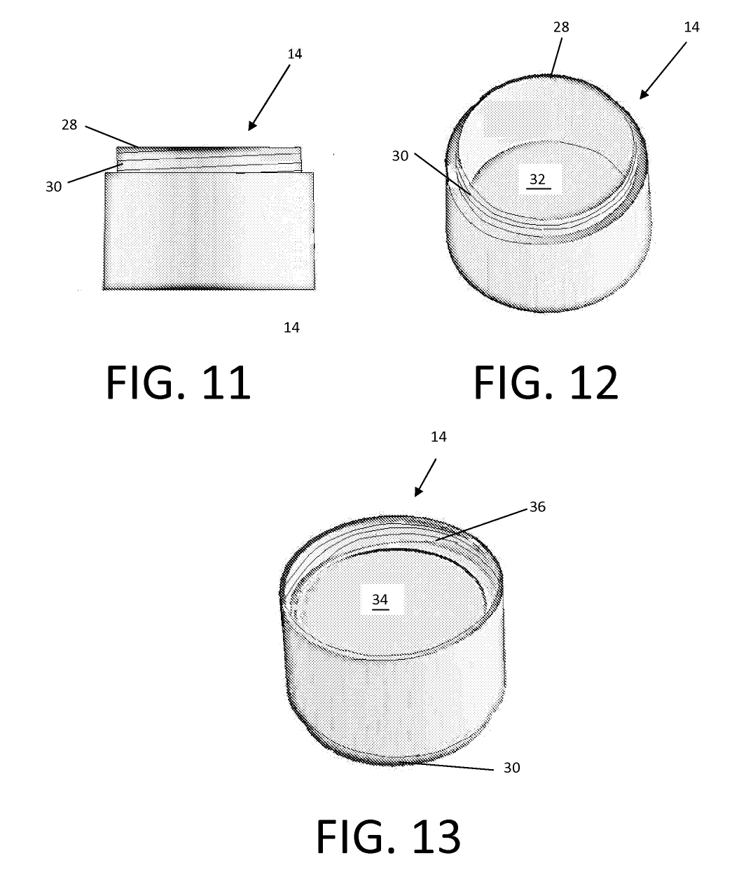

The example container 10 shown in FIGS. 1-13 is a portable medicament/water container 10 that may be easily stored in a user's purse or pocket in order to allow on-the-go taking of medication. In one example, the container 10 holds fewer than 3 ounces of liquid so that it can be used on airplanes. In another example, the container 10 may hold more than 3 ounces of liquid in order to be used multiple times throughout a period of time.

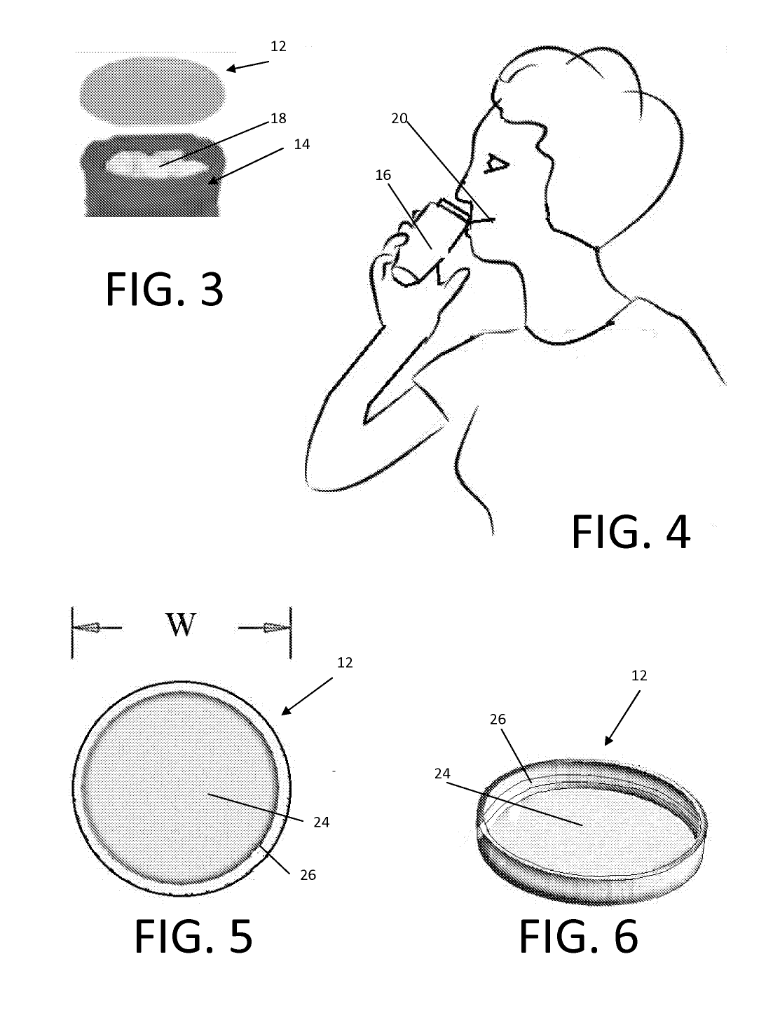

The container 10 is cylindrical and has a lid, top, or cap 12, an intermediate portion 14 and a base portion 16. The terms lid, top, or cap 12 are used interchangeably herein and refer to the uppermost part of the container 10. The lid 12 is positioned on top of the container 10. The intermediate portion 14 is coupled to a bottom of the lid 12 at the top end of the intermediate portion 14 and to a top end of the base portion 16 at the bottom end of the intermediate portion 14. As such, the intermediate portion 14 is positioned between the lid 12 and the base portion 16. The intermediate portion 14 is used to hold medicament 18, such as pills. The intermediate portion 14 is depicted in FIG. 3 with pills positioned inside the container 10 and with the lid 12 detached. The base portion 16 is used to hold a liquid, such as water. Alternatively, the base portion 16 could be used to hold medicament 18, if desired, or some other substance or liquid, if desired. As shown in FIG. 4, the base portion 16 can be used as a cup in order to introduce a liquid or medicament 18 to the user's mouth 20.

Referring to FIGS. 1-2 and 5-8, the top has a substantially smooth upper surface 22, but any type of top can be used. The top 12 has a central recess 24 with screw threads 26 provided around the interior of the recess 24, with the screw threads 26 facing inwardly. Another type of coupling mechanism may be utilized, if desired, including a hinge, a living hinge, or some other type of coupling mechanism.

Referring to FIGS. 1-2 and 11-13, the intermediate portion 14 has an open top and a closed bottom. A ridge 28 is present around the open top and screw threads 30 are positioned around the ridge 28 and face outwardly. The ridge 28 is shown as having an outer diameter that is smaller than an outer diameter of the outer wall of the intermediate portion 14. The screw threads 30 on the ridge 28 are designed for mating with screw threads 26 on bottom end of the top 12. An outer wall of the intermediate portion 14 defines an interior recess 32 or reservoir 32. The bottom of the intermediate portion 14 has a recess 34, similar to the recess 24 in the lid 12, and screw threads 36 are present on an interior of the recess 34. The screw threads 36 face inwardly. The recess 34 in the bottom of the intermediate portion 14 is not absolutely required and is dependent upon the type of coupling mechanism that is used to couple the intermediate portion 14 to the base portion 16. The interior reservoir 32 of the intermediate portion 14 is accessed through the top end of the intermediate portion 14. The recess 32 may be about 20 mm deep and may hold an ounce of liquid or provide room for any number of pills 18, such as ten or more pills 18, for example. Any type of coupling, including screw threads, may be used for joining the intermediate portion 14 to the lid 12 and/or base portions 16.

Referring to FIGS. 1-2 and 8-10, the base portion 16 has an open top and a closed bottom, with a ridge 38 disposed around the open top. Screw threads 40 are shown positioned on the ridge 38 and face outwardly for mating with the inwardly facing screw threads 36 of the bottom of the intermediate portion 14. The ridge 38 has an outer diameter that is smaller than an outer diameter of the outer wall of the base portion 16. Any type of coupling mechanism can be used for closing the base portion 16. Thus, the lid 12 closes the intermediate portion 14 and the intermediate portion 14 closes the base portion 16 when all three parts are installed together. The lid 12 may be configured to close either the intermediate portion 14 or the base portion 16, such that the base portion 16 could be used with the lid 12 alone. The base portion 16 defines an interior reservoir 52 for holding a liquid or medicament 18.

As shown in FIG. 1, the three parts of the container 10 define the exterior of the container 10, which is generally cylindrical or tubular with flattened top and bottom ends 42, 44. The example shown in the figures has a wider top and a narrower base, although any type of geometry can be used. It is preferred that the exterior surface be generally smooth and elongated so that the container 10 will not catch on items in a purse or in a pocket. The top and bottom ends 42, 44 are not required to be flattened and could be rounded or otherwise shaped, if desired.

The lid 12 may be clear 46 or opaque 48 and can be made of a hard plastic material or silicone. The intermediate portion 14 may be made of a clear 46 or opaque 48 material and may be made of a hard plastic material or silicone. The base portion 16 may be clear 46 or opaque 48 and made of a hard plastic material or silicone. Any of the various parts may be colored for aesthetics, or to hide the contents in the container 10 itself. Other types of materials may be used, as known by those of skill in the art. For example, any type of plastic, polymer, glass, metal, or other known material may be used. Ribbing 50 may be provided on an exterior surface of any of the parts in order to assist in gripping the parts.

The example shown in FIG. 1 has ribbing 50 around the lid 12 and around the outer wall of the intermediate portion 14, while the base portion 16 has a generally smooth exterior. The ribbing 50 may be continuous on the outer surface or positioned at spaced locations. The top 12 and base portion 16 are shown to be made of a clear material 46, while the intermediate portion 14 is shown as opaque 48 in order to hide the contents of the intermediate portion 14 and also to provide the container 10 with an aesthetically pleasing appearance.

Conventional screw threads may be used as a coupling mechanism for coupling the various parts together. Alternatively, bayonet mount threads may be used. Any known type of threads may be used as long as they provide for a water tight seal between the base portion 16 and the intermediate portion 14. Other types of coupling mechanisms may be used to provide a water tight seal at least between the base portion 16 and the intermediate portion 14. There also may be times when the intermediate portion 14 is used for holding a liquid medicine 18. Thus, it may also be desirable to ensure that there is a water tight seal between the intermediate portion 14 and the lid 12.

The base, as shown in FIGS. 1-2 and 8-10, is designed to hold a small amount of liquid, such as 2 ounces. Other quantities of liquid may be used if desired, although a 2 ounce base will permit for the container 10 to be taken on an airplane in carry-on luggage. The interior reservoir 32 of the intermediate portion 14, as shown, has an approximate interior depth of about 20 mm, which will permit multiple pills or other medicament 18 to be stored in the intermediate portion 14. Other sizes for the intermediate portion 14 may be substituted.

Any number of intermediate sub-containers for storing pills may be used (not shown), that are like the intermediate portion 14. There may be 2, 3, 4 or more sub-containers. The sub-containers may be written on to note the type of drink or pill contained therein or other information, such as when medicine should be taken. The exterior surface of each portion may include a surface that permits a message to be written or printed on the surface, or a spot for positioning a label (not shown). The example container 10 may store any type of pill 18, including medicines, vitamins, supplements, breath fresheners, etc. The pills 18 may be in the form of capsules, tablets, or other forms. Chambers for holding the pills 18 preferably have a capacity of about 25 to about 40 ml, but may be larger or smaller, if desired.

In use, the user removes the lid 12, takes a pill 18 out of the intermediate portion 14, opens the base portion 16 by removing the intermediate portion 14 from the base; and drinks the water in the base portion 16 along with the pill 18. The user may first close the intermediate portion 14 with the lid 12 after removing the medicament 18 and before opening the base portion 16, if desired. The exterior of the container 10 is smooth without any sharp corners, although the container 10 may have ribbing 50 or similar surface treatment for assisting in opening the various parts of the container 10. The example container 10 is easy to carry in a pocket or purse.

The drink that is stored may be water, a fruit drink, coffee, tea, or other type of drink, as desired. The material of the container 10 may be designed so that it does not react to any of the above-noted substances. The chamber 52 for holding the drink is larger than the pill chambers 32 and should have a capacity sufficient to hold enough drink to enable an average person to take at least one of the pills. The water reservoir 52 may be designed to allow the user to take all or more than one of the pills 18 stored in the intermediate portion 14. About 90 to about 100 ml is preferred for the container 10 of FIG. 1, where there is a single pill compartment, and about 120 to about 150 ml is preferred when there are multiple pill compartments or multiple pills to be taken.

The containers 10 may be made of plastic, such as acrylic or other types of plastics. Other materials may alternatively be used, such as glass, ceramics, and various metals, if desired The containers 10 may be transparent 46 so that their contents may be viewed without opening them, or may be opaque 48 in order to prevent the contents from being reviewed, They may also be colored or have designs on them. An example overall container 10 may have width W of about 40 mm and a length L of about 105 mm. An example base portion 16 may have a length L1 of about 75 mm. An example intermediate portion 14 may have a length L2 of about 28 mm, An example lid 12 may have a length L3 of about 7 mm. Other sizes are also contemplated. The edges of the container 10 may be smooth, squared, curved, or beveled, as desired. The container 10 may be shatterproof so that it is not susceptible to breakage if dropped.

A combined medicament 18 and beverage container 10 includes a first reservoir, a second reservoir, and a lid 12. The first reservoir has a cylindrical shape with a closed base and an open top, with a threaded portion positioned around the open top. The second reservoir has a cylindrical shape and an open top with a threaded portion positioned around the open top. The threaded portion at the bottom of the second reservoir is for mating with the threaded portion of the first reservoir. The lid 12 has an open bottom with a threaded portion positioned at the open bottom. The open bottom is for mating with the threaded portion at the top of the second reservoir. The first reservoir, second reservoir, and lid 12 all have substantially the same outer diameter where the first reservoir, second reservoir and lid 12 mate in order to provide a smooth exterior where they mate.

The first reservoir, second reservoir and lid 12 may be axially aligned with one another. The first reservoir may have a capacity of about 1 to 3 ounces and the second reservoir is smaller than the first reservoir. The first and second reservoirs may be water tight when coupled together with the lid 12. The container 10 may be made of glass or plastic. The first reservoir may be transparent, the second reservoir may be opaque, and the lid 12 may be opaque. The first reservoir, second reservoir, and lid 12 may be one of transparent or opaque. The base of the first reservoir may be substantially flat in order to allow the first reservoir to seat on a surface.

The container 10 may also include a third reservoir having a threaded portion at a base thereof, and a threaded portion at an open top thereof, with the lid 12 coupling to the open top of the third reservoir and the base coupling to the top of the second reservoir.

A combined medicament 18 and beverage container 10 includes a first reservoir, a second reservoir and a lid 12. The first reservoir has a closed base and an open top, with a coupling portion positioned around the open top. The second reservoir has an open top and a closed base, with a coupling portion positioned around the open top and at the closed base for mating with the coupling portion of the first reservoir. The lid 12 has an open bottom and a closed top with a coupling portion positioned at the open bottom, with the open bottom for mating with the open top of the second reservoir. Each of the coupling portions is configured to prevent a liquid stored in the respective reservoir from leaking from the reservoir, and the container 10 is reusable.

The first reservoir, second reservoir and lid 12 are axially aligned with one another, and the first reservoir may have a capacity of about 2 ounces. The first reservoir may have a capacity of about 1 to 3 ounces and the second reservoir is smaller than the first reservoir.

The container 10 may also have a third reservoir with a coupling portion positioned at a base thereof. The coupling portion may be at an open top end thereof. The lid 12 may couple with the open top of the third reservoir and the base may couple to the top of the second reservoir. Each of the coupling portions of the third reservoir may be configured to prevent a liquid stored in the third reservoir and second reservoir from leaking, and the first reservoir may have a capacity of about 2 ounces.

The first reservoir may be transparent, the second reservoir may be opaque, and the lid 12 may be opaque. The first reservoir, second reservoir, and lid 12 may be one of transparent or opaque. The base of the first reservoir may be substantially flat in order to allow the first reservoir to seat on a surface. The base of the second reservoir may permit the second reservoir to seat on a surface. Ribbing 50 may be provided on an outer surface of at least one of the first reservoir, the second reservoir, or the lid 12.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A combined medicament and beverage container comprising:
a first reservoir having a substantially cylindrical shape with a closed base and an open top, with a threaded portion positioned around the open top;
a second reservoir having a cylindrical shape and an open top with a threaded portion positioned around the open top, and a threaded portion at the bottom of the second reservoir for mating with the threaded portion of the first reservoir; and
a lid 12 having an open bottom with a threaded portion positioned at the open bottom, with the open bottom for mating with the threaded portion at the top of the second reservoir,
wherein the first reservoir, second reservoir, and lid 12 all have substantially the same outer diameter at a point where the first reservoir, second reservoir and lid 12 mate in order to provide a smooth exterior where they mate.

2. The container of claim 1, wherein the first reservoir, second reservoir and lid 12 are axially aligned with one another.

3. The container of claim 1, wherein the first reservoir has a capacity of about 1 to 3 ounces and the second reservoir is smaller than the first reservoir.

4. The container of claim 1, wherein the first and second reservoirs are water tight when coupled together with the lid 12.

5. The container of claim 1, wherein the container is made of glass or plastic.

6. The container of claim 1, wherein the first reservoir is transparent, the second reservoir is opaque, and the lid 12 is opaque.

7. The container of claim 1, wherein the first reservoir, second reservoir, and lid 12 are one of transparent or opaque.

8. The container of claim 1, wherein the base of the first reservoir is substantially flat in order to allow the first reservoir to seat on a surface.

9. The container of claim 1, further comprising a third reservoir having a threaded portion at a base thereof, and a threaded portion at an open top thereof, wherein the lid 12 couples to the open top of the third reservoir and the base couples to the top of the second reservoir.

10. A combined medicament and beverage container comprising:
a first reservoir having a closed base and an open top, with a first coupling portion positioned around the open top;
a second reservoir having an open top and a closed base, with a second coupling portion positioned around the open top and at the closed base for mating with the first coupling portion of the first reservoir; and
a lid 12 having an open bottom and a closed top with a third coupling portion positioned at the open bottom, with the open bottom for mating with the open top of the second reservoir,
wherein each of the first, second and third coupling portions is configured to prevent a liquid stored in the respective reservoir from leaking from the reservoir, and the container is reusable.

11. The container of claim 10, wherein the first reservoir, second reservoir and lid 12 are axially aligned with one another, and the first reservoir has a capacity of about 2 ounces.

12. The container of claim 10, wherein the first reservoir has a capacity of about 1 to 3 ounces and the second reservoir is smaller than the first reservoir.

13. The container of claim 10, further comprising a third reservoir having a fourth coupling portion at a base thereof, and a fifth coupling portion at an open top thereof, wherein the lid 12 couples to the open top of the third reservoir and the base couples to the top of the second reservoir.

14. The container of claim 13, wherein each of the fourth and fifth coupling portions of the third reservoir is configured to prevent a liquid stored in the third reservoir and second reservoir from leaking, and the first reservoir has a capacity of about 2 ounces.

15. The container of claim 10, wherein the first reservoir is transparent, the second reservoir is opaque, and the lid 12 is opaque.

16. The container of claim 10, wherein the first reservoir, second reservoir, and lid 12 are one of transparent or opaque.

17. The container of claim 10, wherein the base of the first reservoir is substantially flat in order to allow the first reservoir to seat on a surface.

18. The container of claim 10, wherein the base of the second reservoir permits the second reservoir to seat on a surface.

19. The container of claim 10, wherein ribbing is provided on an outer surface of at least one of the first reservoir, the second reservoir, or the lid 12.
